(19) United States
(12) Patent Application Publication
(10) Pub. No.: US 2020/0128839 A1
(43) Pub. Date: Apr. 30, 2020

(54) PRE-WORKOUT COFFEE CREAMER COMPOSITION

(71) Applicant: Alex Mumma, Idaho Falls, ID (US)

(72) Inventor: Alex Mumma, Idaho Falls, ID (US)

(21) Appl. No.: 16/663,632

(22) Filed: Oct. 25, 2019

Related U.S. Application Data
(60) Provisional application No. 62/750,729, filed on Oct. 25, 2018.

(51) Int. Cl. A23C 11/10; A23F 5/14; A23L 29/00; A23L 33/15

(52) U.S. Cl. CPC A23C 11/10; A23F 5/14; A23L 33/15; A23L 29/035; A23L 29/045; A23L 29/055

(57) ABSTRACT

A pre-workout coffee creamer composition including a powdered workout supplement in the form of a non-dairy creamer which may be added to coffee or tea to deliver nutrients orally to boost energy. The non-dairy creamer includes a mixture of creatine, Beta-alanine, L-arginine, at least one flavoring agent, at least one B vitamin, Taurine, Tyrosine, electrolytes, and a sweetener. The composition may be provided in a powdered or liquid form. The non-dairy creamer may further include caffeine.

### CROSS REFERENCE TO RELATED APPLICATION

The present application is related to and claims priority to U.S. Provisional Patent Application No. 62/750,729 filed Oct. 25, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. FIELD OF THE INVENTION

The present invention relates generally to the field of food or edible material and more specifically relates to a coffee creamer.

### 2. DESCRIPTION OF RELATED ART

Pre-workout supplement may be commonly combined with water and other liquids. People may end up drinking coffee/tea before a workout, along with being forced to consume their liquid supplement. People may be unhappy or inconvenienced with having to drink two beverages before a workout. Without coffee/tea, some individuals may lack energy throughout their morning routine. A suitable solution is desired.

U.S. Pub. No. 2006/0134300 to Arnold Newman relates to a nutritional supplement for caffeine-containing beverages. The described nutritional supplement for caffeine-containing beverages includes an alertness inducing composition which contains the active ingredients caffeine and taurine and various inert substances in a dry formulation. Caffeine and taurine are delivered in an oral formulation that obviates the need for ingesting significant quantities of liquid or sugar.

### BRIEF SUMMARY OF THE INVENTION

In view of the foregoing disadvantages inherent in the known food or edible material art, the present disclosure provides a novel pre-workout coffee creamer composition. The general purpose of the present disclosure, which will be described subsequently in greater detail, is to provide a pre-workout coffee creamer composition to boost energy and provide a caffeinated beverage flavored creamer and nutritional supplement combination.

A pre-workout coffee creamer composition is disclosed herein. The pre-workout coffee creamer composition includes a non-dairy creamer comprising a mixture of the following ingredients 500 mg of creatine, 1000 mg of Beta-alanine, 500 mg of L-arginine, 10 mg niacin and an additional 2.5 mg of the at least one B vitamin (thiamine, riboflavin, pantothenic acid, pyridoxine, biotin, folic acid, and cobalamin), 100 mg of Taurine, 100 mg of Tyrosine, electrolytes, a sweetener such as sucralose, and at least one flavoring agent. In one embodiment, the non-dairy creamer further includes 100 mg of Caffeine. In a non-caffeinated version, caffeine is not added to the composition. The non-dairy creamer may be provided in a liquid form or a powdered form. The non-dairy creamer may be added to a caffeinated beverage such as coffee or tea and deliver pre-workout nutrients and caffeine orally to boost energy and alertness.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a pre-workout coffee creamer composition, constructed and operative according to the teachings of the present disclosure.

FIG. 1 is a perspective view of the pre-workout coffee creamer composition during an ‘in-use’ condition, according to an embodiment of the disclosure.

FIG. 2 is a perspective view of the pre-workout coffee creamer composition of FIG. 1, according to an embodiment of the present disclosure.

FIG. 3 is an ingredients list for the pre-workout coffee creamer composition of FIG. 1, according to an embodiment of the present disclosure.

FIG. 4 is an ingredients list for the pre-workout coffee creamer composition of FIG. 1, according to an embodiment of the present disclosure.

FIG. 5 is an ingredients list for the pre-workout coffee creamer composition of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a food or edible material and more particularly to a pre-workout coffee creamer composition as used to improve the use of coffee creamers to provide a nutritional and alertness inducing composition for caffeinated beverages.

Generally, the present invention provides users with a powdered workout supplement in the form of coffee creamer capable of being added to coffee or tea. The product features various ingredients used to provide protein and energy boosts before a workout. It includes different flavors designed to customize the taste of coffee/tea while still obtaining pre-workout supplements. The product enables users to customize coffee/tea with a secondary caffeine-free product. The present invention combines two different drinks into one for convenient consumption. Pre-workout coffee creamer composition is a non-dairy powdered or liquid creamer integrated with pre-workout supplements. The creamer can be added to tea/coffee during a morning routine to obtain all supplements required to complete workouts and daily routines without having to consume multiple beverages. The creamer can be caffeinated or non-caffeinated.

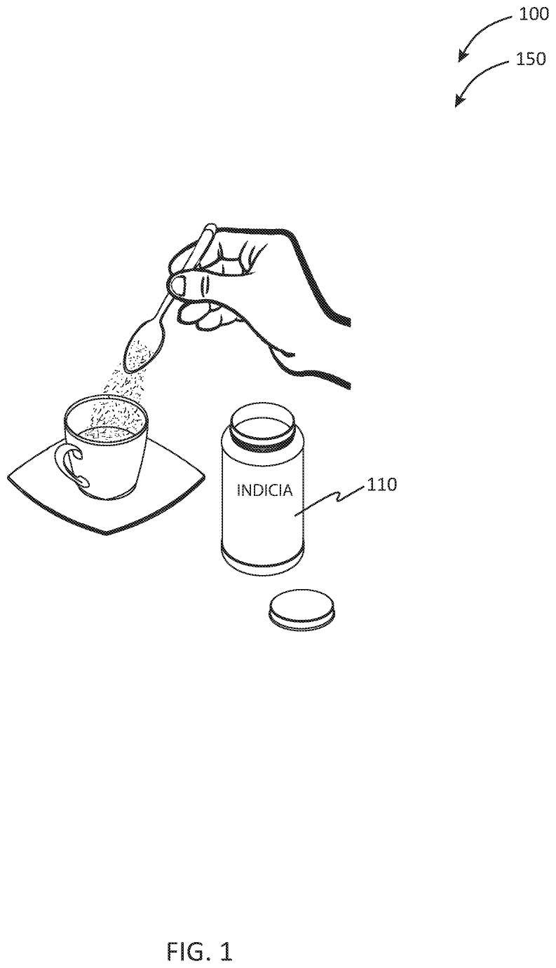

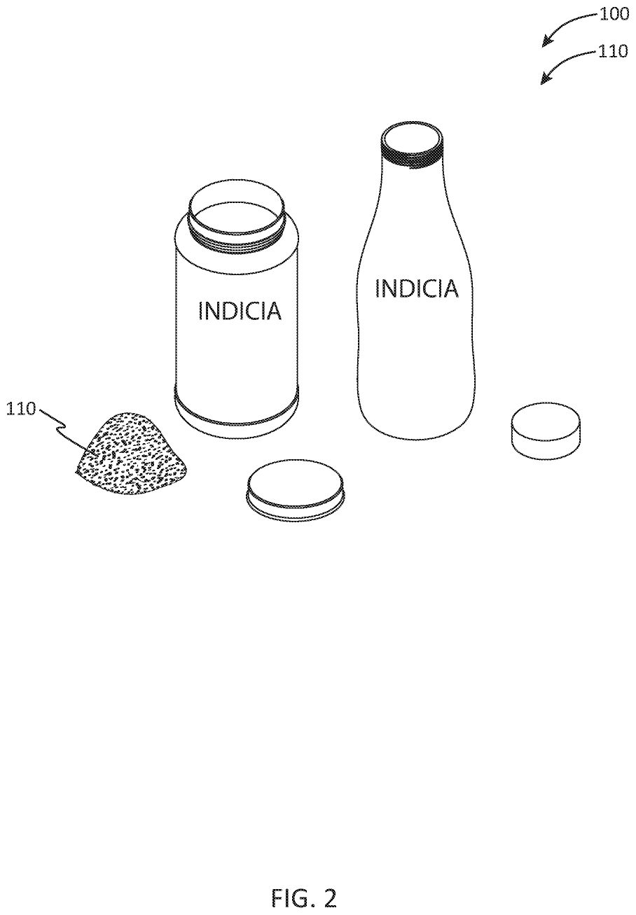

Referring now more specifically to the drawings by numerals of reference, there is shown in FIGS. 1-2, various views of a pre-workout coffee creamer composition 100. FIG. 1 shows a pre-workout coffee creamer composition 100 during an ‘in-use’ condition 150, according to an embodiment of the present disclosure. As illustrated, the pre-workout coffee creamer composition 100 may include a powdered workout supplement in the form of non-dairy creamer 110 capable of being added to coffee or tea. The pre-workout coffee creamer composition 100 includes a mixture of ingredients which provide protein and sustainable energy.

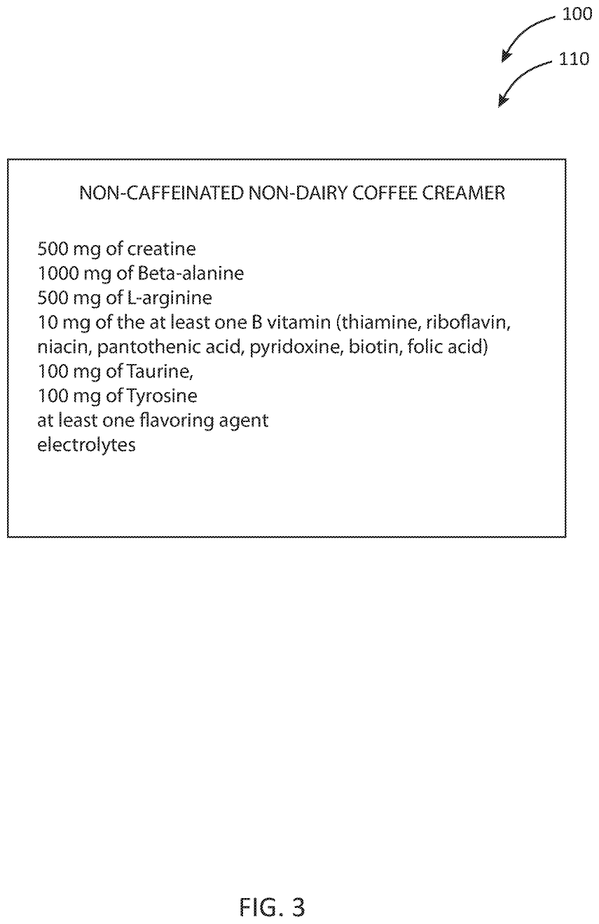

FIG. 3 shows an ingredients list of the pre-workout coffee creamer composition 100 of FIG. 1, according to an embodiment of the present disclosure. As above, the pre-workout coffee creamer composition 100 may include a non-dairy creamer 110 including a mixture of creatine, Beta-alanine, L-arginine, at least one flavoring agent, at least one B vitamin, Taurine, and Tyrosine. In a preferred non-caffeinated version, the non-dairy creamer 110 comprises 500 mg of creatine, 1000 mg of Beta-alanine, 500 mg of L-arginine, 10 mg of the at least one B vitamin, 100 mg of Taurine, 100 mg of Tyrosine, and at least one flavoring agent. The composition 100 may be added to a caffeine-containing beverage such as coffee and tea. The composition 100 may be provided in a variety of flavors such as but not limited to pumpkin spice, peppermint, Irish Cream, red velvet, caramel macchiato, white chocolate.

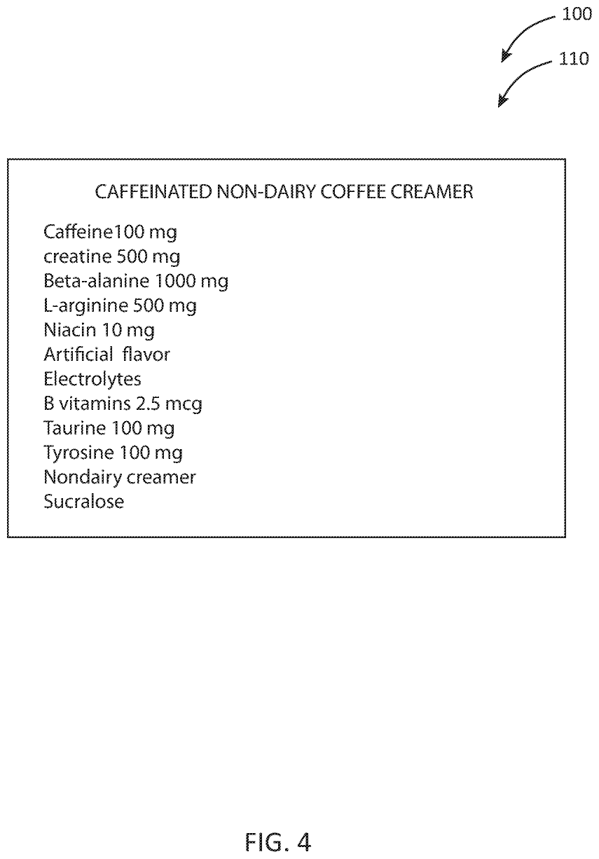

FIG. 4 shows an ingredients list of the pre-workout coffee creamer composition 100 of FIG. 1, according to an embodiment of the present disclosure. In an alternative, caffeinated embodiment, the composition 100 comprises a non-dairy creamer 110 comprising a mixture of the following ingredients 500 mg of creatine, 1000 mg of Beta-alanine, 500 mg of L-arginine, 10 mg of the at least one B vitamin, 100 mg of Taurine, 100 mg of Tyrosine, 100 mg of Caffeine, and at least one flavoring agent. The composition 100 may further include electrolyte additives and an artificial sweetener. The at least one B vitamin may include thiamine, riboflavin, niacin, pantothenic acid, pyridoxine, biotin, folic acid, and cobalamin, or a combination thereof. The non-dairy creamer 110 may be provided in a powdered form or liquid form.

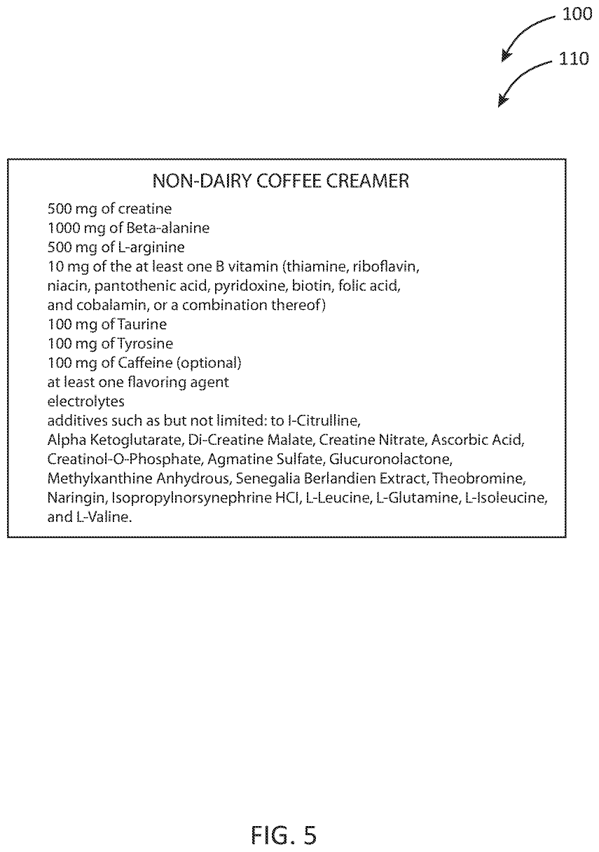

FIG. 5 shows an ingredients list of the pre-workout coffee creamer composition 100 of FIG. 1, according to an embodiment of the present disclosure. As above, the pre-workout coffee creamer composition 100 may comprise the non-dairy creamer 110 including a mixture of creatine, Beta-alanine, L-arginine, at least one flavoring agent, at least one B vitamin, Taurine, Tyrosine, electrolytes, and a sweetener providing a non-dairy creamer integrated with pre-workout supplements and nutrients for boosting energy. The non-dairy creamer 110 may further include nutritional additives such as but not limited to I-Citrulline, Alpha Ketoglutarate, Di-Creatine Malate, Creatine Nitrate, Ascorbic Acid, Creatinol-O-Phosphate, Agmatine Sulfate, Glucuronolactone, Methylxanthine Anhydrous, Senegalia Berlandien Extract, Theobromine, Naringin, Isopropylnorsynephrine HCl, L-Leucine, L-Glutamine, L-Isoleucine, and L-Valine.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A composition comprising:
a non-dairy creamer including;
creatine;
Beta-alanine;
L-arginine;
at least one flavoring agent;
at least one B vitamin;
Taurine; and
Tyrosine.

2. The composition of claim 1, comprising 500 mg of said creatine.

3. The composition of claim 2, comprising 1000 mg of said Beta-alanine

4. The composition of claim 3, comprising 500 mg of said L-arginine.

5. The composition of claim 4, comprising 10 mg of said at least one B vitamin.

6. The composition of claim 5, comprising an additional 2.5 mg of said at least one B vitamin.

7. The composition of claim 6, comprising 100 mg of said Taurine.

8. The composition of claim 7, comprising 100 mg of said Tyrosine.

9. The composition of claim 1, further comprising caffeine.

10. The composition of claim 1, further comprising electrolytes.

11. The composition of claim 1, further comprising a sweetener.

12. The composition of claim 11, wherein said sweetener is an artificial-sweetener.

13. The composition of claim 1, wherein said non-dairy creamer is provided in a liquid form.

14. The composition of claim 1, wherein said non-dairy creamer is provided in a powdered form.

15. The composition of claim 1, comprising no added caffeine.

16. The composition of claim 1, wherein said composition is added to a caffeine-containing beverage which is selected from the group consisting of coffee and tea.

17. The composition of claim 6, wherein said at least one B vitamin includes thiamine, riboflavin, niacin, pantothenic acid, pyridoxine, biotin, folic acid, and cobalamin.

18. The non-dairy creamer composition of claim 1, further comprising nutritional additives selected from the group consisting of I-Citrulline, Alpha Ketoglutarate, Di-Creatine Malate, Creatine Nitrate, Ascorbic Acid, Creatinol-O-Phosphate, Agmatine Sulfate, Glucuronolactone, Methylxanthine Anhydrous, Senegalia Berlandien Extract, Theobromine, Naringin, Isopropylnorsynephrine HCl, L-Leucine, L-Glutamine, L-Isoleucine, and L-Valine.

19. A pre-workout coffee creamer composition, the pre-workout coffee creamer composition comprising:
a non-dairy creamer including;
500 mg of creatine;
1000 mg of Beta-alanine;
500 mg of L-arginine;
10 mg of the at least one B vitamin;
100 mg of Taurine;
100 mg of Tyrosine;
100 mg of Caffeine; and
at least one flavoring agent;
wherein said composition further comprising electrolyte additives;
wherein said composition further comprising a sweetener;
wherein the non-dairy creamer is provided in a powdered form;
wherein the composition is added to a caffeine-containing beverage which is selected from the group consisting of coffee and tea;
wherein said at least one B vitamin includes thiamine, riboflavin, niacin, pantothenic acid, pyridoxine, biotin, folic acid, and cobalamin; and
wherein said composition further comprising nutritional additives selected from the group consisting of I-Citrulline, Alpha Ketoglutarate, Di-Creatine Malate, Creatine Nitrate, Ascorbic Acid, Creatinol-O-Phosphate, Agmatine Sulfate, Glucuronolactone, Methylxanthine Anhydrous, Senegalia Berlandien Extract, Theobromine, Naringin, Isopropylnorsynephrine HCl, L-Leucine, L-Glutamine, L-Isoleucine, and L-Valine.

20. A pre-workout coffee creamer composition, the pre-workout coffee creamer composition comprising:
a non-dairy creamer including;
500 mg of creatine;
1000 mg of Beta-alanine;
500 mg of L-arginine;
10 mg of the at least one B vitamin;
100 mg of Taurine;
100 mg of Tyrosine; and
at least one flavoring agent;
wherein said composition further comprising electrolyte additives;
wherein said composition further comprising a sweetener;
wherein the non-dairy creamer is provided in a powdered form;
wherein the composition is added to a caffeine-containing beverage which is selected from the group consisting of coffee and tea;
wherein said at least one B vitamin includes thiamine, riboflavin, niacin, pantothenic acid, pyridoxine, biotin, folic acid, and cobalamin; and
wherein said composition further comprising nutritional additives selected from the group consisting of I-Citrulline, Alpha Ketoglutarate, Di-Creatine Malate, Creatine Nitrate, Ascorbic Acid, Creatinol-O-Phosphate, Agmatine Sulfate, Glucuronolactone, Methylxanthine Anhydrous, Senegalia Berlandien Extract, Theobromine, Naringin, Isopropylnorsynephrine HCl, L-Leucine, L-Glutamine, L-Isoleucine, and L-Valine.
